(19) United States
(12) Patent Application Publication
(10) Pub. No.: US 2010/0176318 A1
(43) Pub. Date: Jul. 15, 2010

(54) Shape retentive flexible radiation absorber

(76) Inventor: Peter C. Smith, Half Moon Bay, CA (US)

Correspondence Address: Peter C. Smith, 2411 S Cabrillo Hwy., Half Moon Bay, CA, 94019, US

(21) Appl. No.: 12/319,873

(22) Filed: Jan. 13, 2009

(51) Int. Cl. G21F 3/02

(52) U.S. Cl. 250/519.1

(57) ABSTRACT

The invention is a composite radiation absorber made up of a rubber or rubber like matrix material filled containing a radiation absorptive element, or a plurality of radiation absorptive elements, combined with deformable and shape retentive member or members that once deformed into a desired shape will essentially retain that shape for the composite in use. Ibis shape retentive characteristic offers significant advantages to users in the rapid and complete shielding of undesirable radiation fields.

No prior art could be found relating to the useful combination of these shape retentive elements used in otherwise flexible composite radiation absorptive materials.

### BRIEF DESCRIPTION OF INVENTION

The invention involves a flexible radiation shielding material made up of elastic, radiation shielding, and shape retentive elements that in use has the ability to be readily formed into a conformal shape and retain that shape.

### BACKGROUND OF INVENTION

Currently radiation shielding articles used for high energy ionizing radiation contain high atomic number absorptive elements for instance metals like lead, barium, tungsten and others. This construction normally makes these articles heavy. Shielding articles are normally strategically held in place to maximize shielding efficiency by some external means. In the case of fixed absorbers used to construct radiation proof rooms, the absorptive materials are held in place by the wall, ceiling and floor structures. In the case of mobile radiation absorbers used in medical imaging and treatment, permanent wheels and or clamps hold them into the desired positions. In the cases where flexible absorber blankets or shaped articles are for use in nuclear power or nuclear propulsion generation facilities, or for spent nuclear waste treatment or storage facilities, it is common practice to drape or wrap blankets around radioactive articles to shield them, or to drape or wrap blankets over special supportive racks designed to facilitate rapid installation of the shields and or to carry the weight of the shields. Grommets are also commonly used to secure these installations by using cumbersome supplemental tie cords either to the article being shielded or to the specially constructed supplemental framework.

These limitations create significant additional effort to plan and install the radiation shielding materials. This results in inefficiency in the amount and weight of radiation shielding material required for a shielding task and in some cases results in higher than required radiation doses to be received by the installation personnel. In some cases the space available or geometry of installation does not allow for these options to be effectively utilized.

### Advantages of the Invention verses Current Practice

The shape retentive Flexible Radiation Absorber allows rapid installation of the minimum absorptive material as is required for the task as it is a squeeze or wrap in place option for a shape conformal absorber. The result is an efficient installation that uses a minimum of shielding material. Since the installation process is rapid, installer dose is minimize in circumstances where radioactive emissions cannot be stopped.

In the case of shielding required for medical, dental or animal procedures, the flexible but shape retentive absorber also carries significant benefits in keeping the shield in place during a given procedure.

### DRAWINGS AND DESCRIPTIONS OF THE INVENTION

FIG. 1 shows a sheet of absorber constructed of a flexible matrix 1. that could be a rubber or rubber-like polymeric material that is filled with descrete particles 2. of radiation absorptive material often a metal or a metal containing compound or mixtures thereof, together with a deformable member 3. which is bonded to members 1. and 2. to create a composite structure. When the composite structure is deformed, the deformable member 3. essentially remains deformed and maintains the shape of the entire composite in the deformed shape. Member 3. can be metal wires, wire segments, sheets, and can be randomly oriented, or ordered in the structure. Alternatively member 3. can be a thermoplastic polymer to allow the composite to first me heated, deformed to a desired shape, and then cooled to retain the desired shape.

FIG. 2. is a similar to the elements 1. and 2. as shown in FIG. 1. but the shapeable element 3 is a woven wire mesh oriented to allow distortion and shape retention in the desired use direction. FIG. 2. shows a sheet formed product that has been deformed to partly wrap around a cylindrical shaped object (not shown).

FIG. 3. is a composite with elements 1. and 2. as FIG. 1. but with the shape retentive element 3. shown as wires or as wires rolled flat as strips in a manner to promote adhesion and or deformation.

FIG. 4. shows a composite absorber as FIG. 3. wrapped around a cylindrical shape to retain its position during use.

FIG. 5. is a composite with elements 1. and 2. as FIG. 2. but with deformable element 3 as a planar element in the form of a sheet located at or near the bending neutral axis. FIG. 6. shows a deformed structure made up of a thermoplastic matrix material 1. and dicrete particles of radiation absorber 2. In this case the shape retentive characteristic is realized by first heating the composite, deforming to composite into the desired shape, and then allowing it to cool.

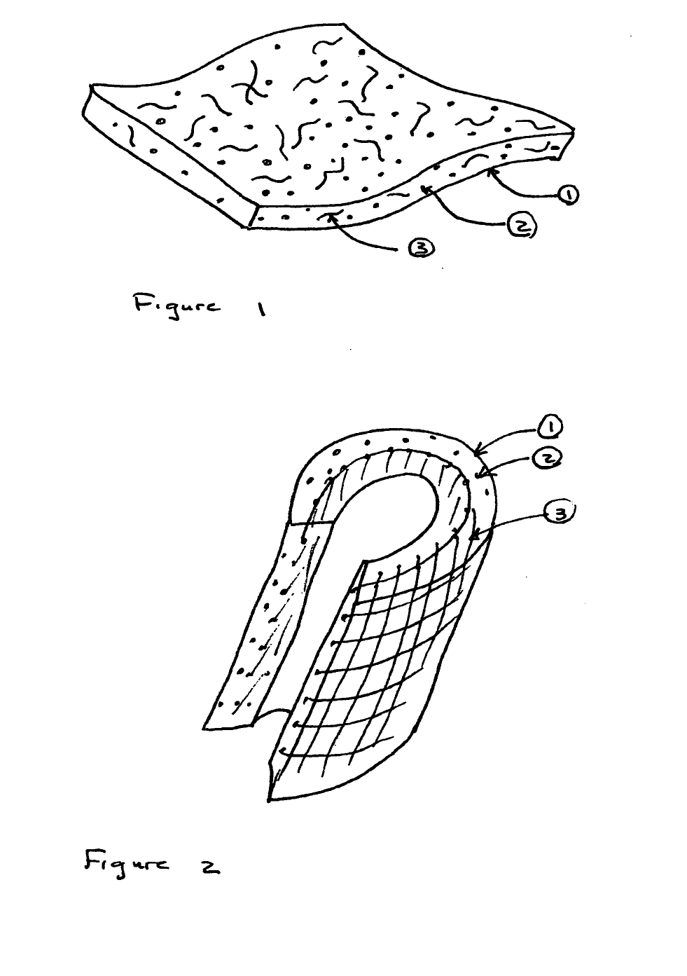

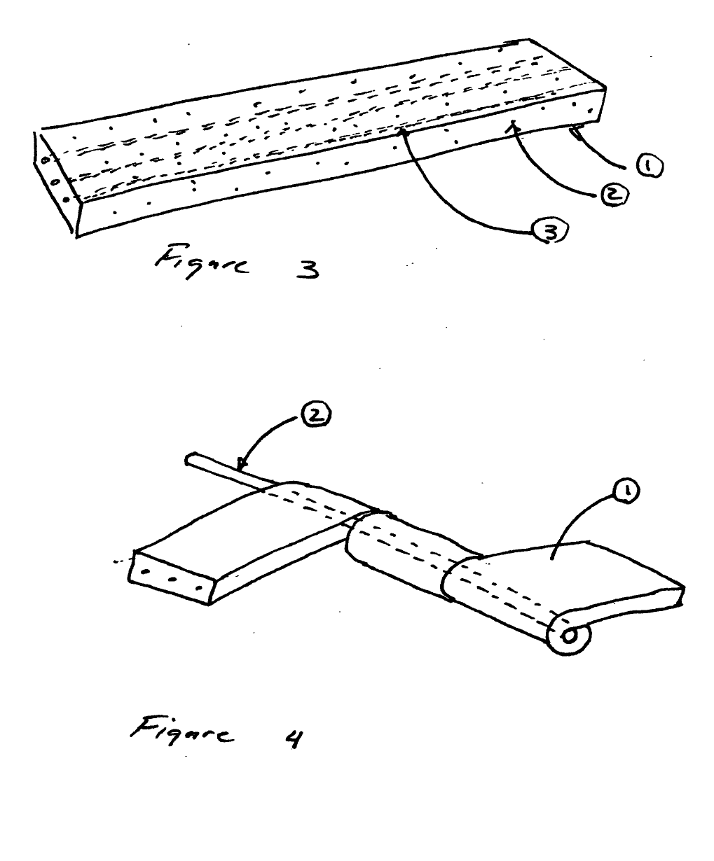

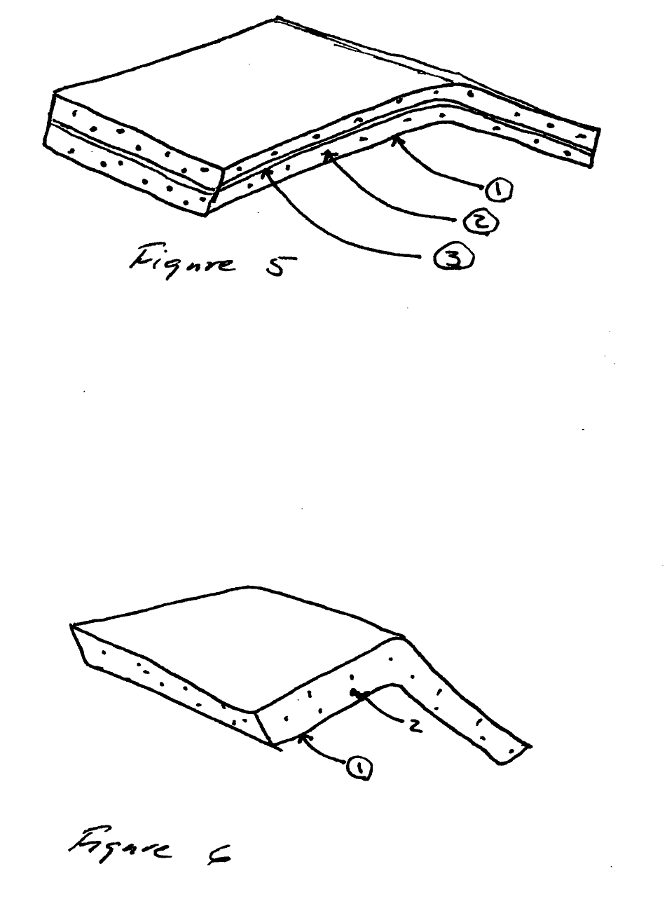

### MANNER AND PROCESS OF MAKING AND USING THE INVENTION

Radiation absorbers are most often produced by forming a single structure through mixing ratios of radiation absorbing particles into a matrix of flexible less absorbent material. Often the particles are added in the form of powders. These powders may be lead, tungsten, barium, bismuth or other high atomic weight materials, or in the case of lower energy radiation or cost sensitive applications powders of iron, manganese, or zinc. Compounds and minerals containing these metals are also effective. The flexible material is either a thermoplastic, a thermo set or a cross likable polymer system such that after forming the mixture will retain the formed shape while alowing some mechanical distortion during application or use. Examples of polymer systems that meet these requirements include Nylons, polyethylenes, styrene block co polymers, paraffin waxes and others in thermoplastics and thermo sets, and polyurethanes, silicones, and others in cross-linkable polymer systems. This invention involves the incorporation of a deformable third element that wants formed will retain the deformed shape. This retained deformation of the third element allows the composite absorber article's flexible matrix to also retain said distortion. The method of manufacture is to place the shape retentive elements into the flexible matrix mixture during the initial porting, casting, injection, rolling or extrusion of the overall absorber shape. Alternately, the shape retentive element can be incorporated between two previously formed absorber shapes in a subsequent bonding operation.

The invention is used by placing the absorber in between the radiation source and the item to be shielded or protected. It may be also installed as part of the item to be shielded, or used as either a permanent or temporary cover for the item.

What is claimed is:

1. A composite radiation absorber made up of a rubber or rubber like matrix material bonded to powdered or granular radiation absorptive to filler particles, combined with a deformable and shape the retentive member or members suitable to hold the composite material in essentially in the deformed shape when released following the deformation process.

2. Claim 1. where the deformable and shape retentive members are soft metal wires or arrays of wires.

3. Claim 1. and where the deformable and shape retentive member or members is a metal sheet or sheets.

4. Claim L were the deformable and shape retentive member is a perforated or expanded metal sheet or sheets.

5. Claim 1. where the deformable and shape retentive member is a thermoplastic polymer in the form of a sheet, fibers, expanded sheet, or shaped member.

6. Claim 1. where the radiation absorptive element is lead, tungsten, bismuth, barium, and compounds or mixtures thereof.

7. Claim 1. where the rubber or rubber-like matrix is natural rubber, latex rubber, silicone rubber, styrene block copolymer, thermoplastic elastomer, polyisoprene, materials with like properties, or mixtures thereof.

8. Claim 1. where the radiation absorptive element is between 75% and 95% by weight of the composite.

9. Claim 1. where the radiation absorptive element is uniformly dispersed in the composite and the shape retentive element is uniformly dispersed in the composite. 10. Claim 1, where the shape retentive element is located near the central axis of bending.

11. Claim 1. where differing radiation absorptive elements are layered, relative to the useful thickness of the absorber to promote specialized spectral radiation absorption properties.
